(19) United States
(12) Patent Application Publication
(10) Pub. No.: US 2003/0090472 A1
(43) Pub. Date: May 15, 2003

(54) Method of controlling function key of local computer per each corresponding programs in the remote control apparatus

(76) Inventor: Kwang Sung Im, In-Chon (KR)

Correspondence Address: Heejung Chun, 18919 Snow Fields Cir., Germantown, MD, 20874, US

(21) Appl. No.: 10/291,047

(22) Filed: Nov. 9, 2002

(30) Foreign Application Priority Data
Nov. 9, 2001 (KR) 10-2002-0045397

(51) Int. Cl. G09G 5/00; G09G 5/08

(52) U.S. Cl. 345/172; 345/158

(57) ABSTRACT

The invention was intended to suit the needs of controlling local computer by remote computer utilizing function keys. This invention also includes lock function, which works in a user designated computer program only whether or not the designated computer program is active, while non-designated computer program stays unaffected.

### BACKGROUND OF THE INVENTION

The invention is intended to utilize that the method of controlling function key of local computer per each corresponding programs in the remote control apparatus.

Due to the recent development of information processing and data communication technology, it is usual to have a personal computer at home, and personal computer is not just for the professional. PCs have become a highly efficient and inexpensive along with the popularization of information technology, and those become communication and data storage method for personal use as much as professionals in corporate use for their presentation, general office work, graphic work, etc.

Computer in general contains a keyboard as input equipment, and the keyboard is connected to the computer by cable. In addition, the keyboard is composed of letter-key, number-key, special-key and function key to receive specific signals such as characters, numbers, special letters or control method. Therefore, when user want to do presentation, he or she has to run the specific computer program such as Power Point Presentation, MS office, etc., and then start to use his or her presentation file on the board thru some sort of displayer. In addition, shifting image or picture is required to use keyboard.

Due to the cable connection between said computer and said keyboard, the presenter has to either place the computer and keyboard together and work from there or need an assistant to help the presenter for changing screen. Otherwise, the presenter has to go back and forth whenever he or she needs to.

In these cases, it may minimize promptness of presentation procedure and the presenter cannot completely concentrate on the presentation. Previously developed screen converter with extended cable allows doing presentation without a hindrance. Said screen converter is small and light enough to carry or use it during the presentation, but said screen converter still contains limitation of disturbing the presentation by the cable connection or by relocating presenter.

Presenter usually use laser pointer when the presenter needs to point out something on the screen. Therefore, the presenter has to perform two tasks simultaneously, that switching the cabled computer indicator to view the next image and pointing laser pointer. It is tough for a presenter to do this multi task.

Wireless keyboard was invented, but said keyboard is still not suitable for the presentation due to the weight and complicated keys. It is also difficult for presenter to memorize function keys, or carry said wireless keyboard or wireless mouse with such a limited distance.

Due to development of various Internet contents, people use their PC as much as they use television or audio system. It would be desirable to have a remote controller for PC just like when we use it for TV or Stereo, but controlling PC is much more complicated than others. Remote controller for PC also requires various applied software, and existing PC remote controller is either supporting only one program or setting the program each time as use. Moreover, if said existing remote controller for PC is located further than about 10 feet away from local computer, it will not properly.

Recently, It is usual to have a dual monitor, which is supported by video card, and PC or Lab top with the dual monitor. It would be desirable to have a remote controlling apparatus per corresponding programs in local computer.

This invention provides the recording medium, which contains method of controlling and modifying function keys per each corresponding programs in the local computer. The invention also contains lock function based on said function keys works in a designated program only whether or not the designated program is active, while non-designated program stays unaffected.

### BRIEF SUMMARY OF THE INVENTION

The invention is intended to provide a method of controlling local computer by remote computer utilizing function keys and providing lock function into a plurality computer program in the local computer. Accordingly, the present invention provides the benefit of controlling a plurality computer program and interfacing multi task with one computer.

### BRIEF DESCRIPTION OF THE DRAWINGS

FIG. 1 is a conceptual diagram of remote computer utilizing function keys;

FIG. 2 is a block diagram of FIG. 1;

FIG. 3 is an external side view of a remote control apparatus for computer;

FIG. 4 is a block diagram of a method, which controls local computer by remote computer utilizing function keys;

FIG. 5 is a block diagram of a method, which controls function key per each corresponding programs;

FIG. 6 is a block diagram of a method, which provides lock function to a designated program in the local computer.

### DETAILED DESCRIPTION

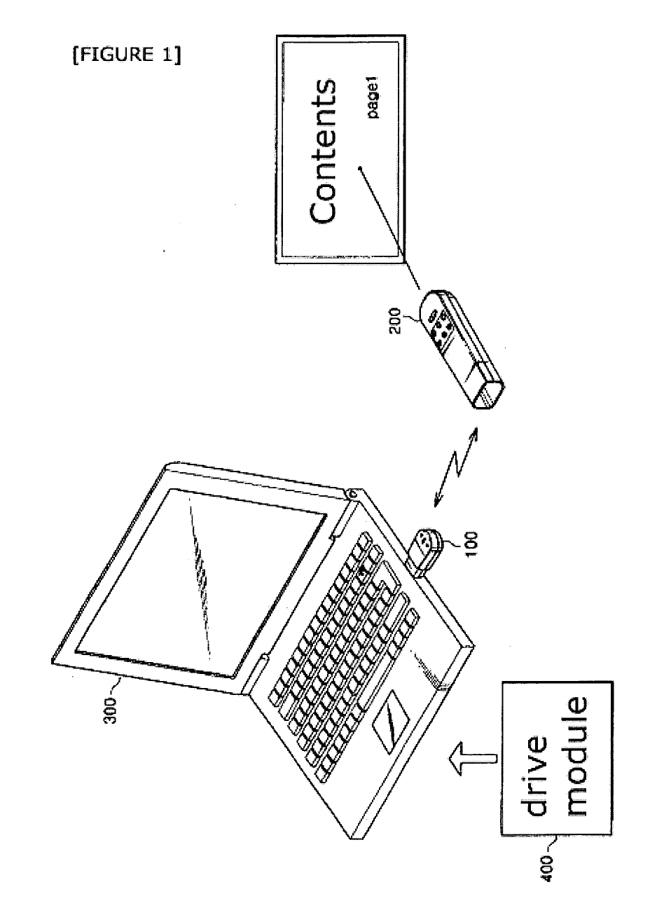

FIG. 1 is a conceptual diagram of controlling local computer by remote control apparatus (100, 200) utilizing function keys. Said remote control apparatus and computer include transmitter (200), receiver (100), and drive module (400). The Transmitter sends RF (Radio Frequency) control signal from encoded, and the Receiver receives and decodes the transmitted RF signal from transmitter and send it to USB port in a local computer.

The Drive Module (400) will be installed in the computer to operate together between the remote control apparatus and the local computer (300). The receiver of the remote control computer device also is connected to USB port physically, and the transmitter is a small size and a lightweight. Both of these are very easy to be assembled or disassembled.

USB port is a series port, which was developed along with Window 98 that is the operational system of the Microsoft Corporation. USB port implies the plug and play interface with the computer A/C such as Audio Player, Joy Stick, Keyboard, Telephone, Scanner, Printer and so on. USB port was offered to the most computers above the Pentium II level and it was standard. After the development of Windows 98, the USB port becomes more stable and various related products were developed.

The concept of the USB port is similar to the one of a series port, but USB port is much easier to be connected than a series port. In addition to that, the USB port has a rapid transmitting speed, 12 Mbps which is good enough to support the surrounding devices and can be connected to up to 127 devices as a link. Therefore, if one connect the receiver from the remote control computer device to the USB port in computer, computer read the information automatically from the remote controller as it come from the surrounding device. After installing drive module in the computer, the remote controller and the computer are working together.

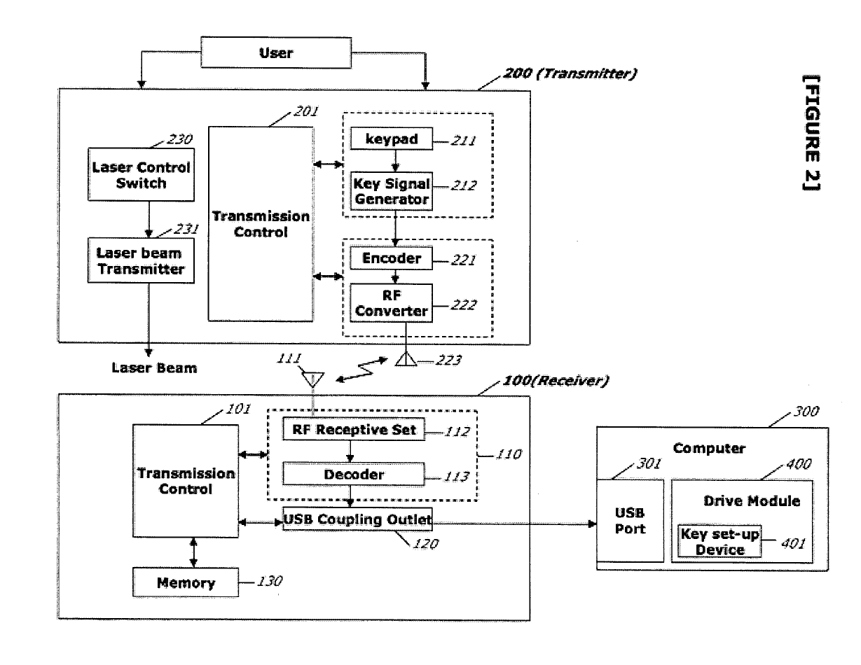

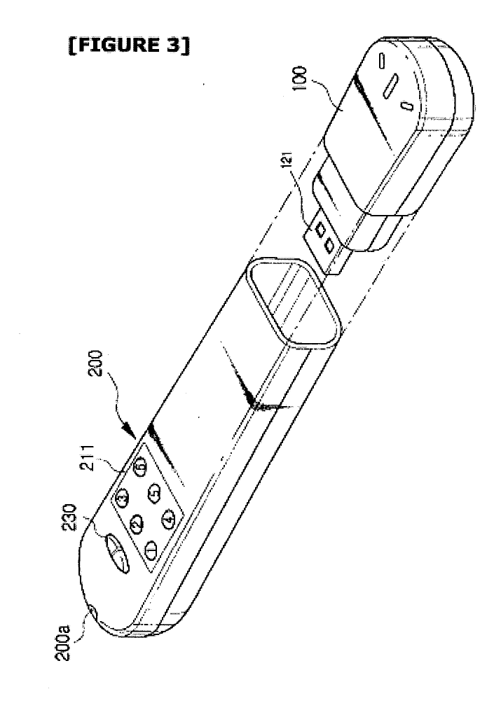

FIG. 2 is a block diagram of FIG. 1. The remote control apparatus is composed of units that comprise the process of receiving and encoding key signal and transmitting said key signal into RF control signal. As shown on FIG. 3, the mutual connection or separation is possible to do so.

Key signal entry part (210) contains a keypad (211), which contain buttons for entering the key values by users' needs, and a key signal generator (212) which produce the key signal per corresponding function keys by user's needs.

The RF transmitter (220) contains an encoder (221), a RF converter (222), and an antenna (223). The encoder converts the key signal to a specific code, and RF converter modifies said encoded key signal into a RF control signal.

To provide the laser pointer function to users, laser pointer's switching unit and laser beam's production units are provided. As shown on the FIG. 3, while holding an “ON” button on a laser control switch, projected laser beam forms a laser point either on the board or on the projector.

Transmission control (201) performs interaction among the transmitting units (210, 220) in the transmitter (200) and controls the flow of signal. A power source (Fig. Is not provided on this plan) is either a battery or a charger. In addition, USB port provides a power to a receiver (100). The Receiver (100) receives a transmitted RF control signal from transmitter (200) and sends it to the local computer (300) through USB port (301).

RF receptive part (110) is composed of antenna (111), RF receiving circuit (112), and decoding circuit (113).

As shown on the FIG. 3, USB coupling outlet (120) includes the connection terminal (121), which is physically connected to the local computer (300), and sends the decoded key signal to the computer (300).

Memory (130) stores the set-up files and other files to interlock installed drive module (400), and it could be used as a data saving tools per user's needs.

Reception control (101) performs an overall control of the receiver (100), and controls especially the interaction and the data flow among the RF receptive part (110), USB joint (120), and memory (130). In addition, the receiver (100) performs the remote control function if the transmitter (200) receives key signals given by user and transmits RF control signals.

FIG. 3 is an external side view of a remote control apparatus for computer, and it shows that ‘100’ as a receiver, ‘121’ as an USB joint terminal, ‘200a’ as a laser beam projection part, ‘211’ as a key pad, and ‘230’ as a laser pointer switch. In addition, the transmitter (200) and the receiver (100) are allowed to assemble or disassemble.

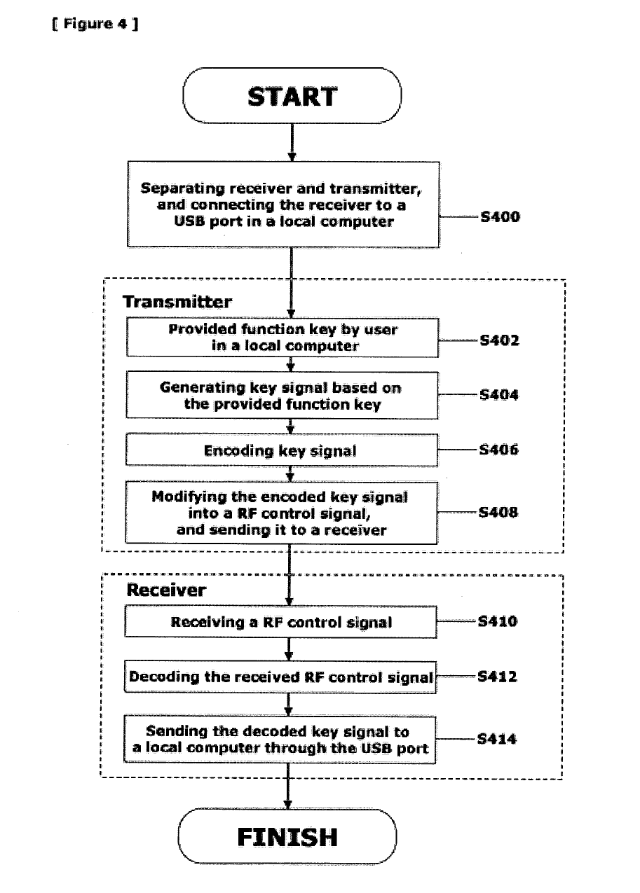

FIG. 4 is a block diagram of a method, which controls local computer by remote computer utilizing function keys. Initially, user connects the USB coupling outlet (121) into the USB port (301) of the local computer (300) for gearing between the remote control apparatus and the computer.

The USB port (301), previously developed from Microsoft Corporation, senses and starts a set-up process automatically when the USB port is connected to another hardware. Therefore, if the USB coupling outlet (121) is connected to the receiver (100), controlling system of the computer (300) senses said hardware and starts to read the remote control apparatus as a part of said local computer. In addition, user will have the message from the computer which is “sensed a new hardware” before said computer starts to read the remote control apparatus as a part of the local computer.

Drive module provides a function for user (500) to control the key values of the keypad (211) in the transmitter (200) as well as an interlocking function between the computer and the remote control apparatus. In addition, drive module provides the function key lock system by modifying said function key per each corresponding programs, so that said lock function works in a designated program only whether or not the designated program is active, while non-designated program stays unaffected. It is possible to control a plurality computer program and to interface the multi task with one computer, once user set up the lock function on the local computer.

For example, if there are six keys on keypad (211) in the transmitter (200), drive module (400) activates the key set-up device (401), which is the sub-program of said drive module (400). Each key performs a different function to control the designated computer program given by user. User would choose their own key set up device (401) based on the program needed, and examples are as followed:

(Sample A: MS PowerPoint)

| Key 1 | Page Down |
|---|---|
| Key 2 | Page Up |
| Key 3 | Forward |
| Key 4 | Backward |
| Key 5 | Left |
| Key 6 | Right |
| (Sample B: Media Player) | |
| Key 1 | Play |
| Key 2 | Stop |
| Key 3 | Forward |
| Key 4 | Backward |
| Key 5 | Volume Up |
| Key 6 | Volume Down |

After completing the key set up, when MS Power Pointer is activated in the drive module (400), each key on the remote control apparatus is recognized as the corresponding function keys of said local computer (300). Likewise, when Media Player is activated, key 1 through 6 are recognized as Ctrl+P, Ctrl+S, Ctrl+Shift+F, Ctrl+Shift+B, F10, and F9.

In addition, user designates the lock function to a specific computer program, and it works in a user designated computer program only whether or not the designated program is active, while non-designated program stays unaffected. It is possible to control various computer programs and to interface the multi task with one computer, once user set up the lock function on the local computer.

For instance, user has two different programs operating, and the function key lock system was set up for only one program. In another words, user was using program “A” and “B” at the same time, and said key lock system was set up for program “B” only. While the program “A” is activated and user types something with Keyboard, user can use the remote control apparatus to activate the program “B”. Although the key value from the remote control apparatus is recognized as same as said key value from the computer, the remote control apparatus transmits the activating key value to the program “B” only.

When the user (500) uses the remote control apparatus during presentation, the USB port (300) in computer (300) has to be connected to the USB coupling outlet (121) in transmitter (100). And the receiver (200) has to be disassembled from the transmitter (see FIG. 3), and then user (500) carries (S400) it.

In the event of presentation, the user (500) enter the key number 1 in the transmitter (200) to switch the screen, and the key signal generator (212) transmits a corresponding key value (S404) to the RF transmittable part (220). And the RF transmittable part (220) encodes the signal with the encoder (221), and it transmits to the receiver (100) through the RF converter (222) and antenna (223).

In addition, the RF receptive part (110) in the receiver (100) receives the RF control signal (S410) from the transmitter (200), decodes (S412), and transmits (S414) the key signal to the computer (300) through the USB joint (120). The computer (300) recognizes this procedure as a page down key as the user previously establish the key set up device (401) of said drive module (400).

Transmitter (200) includes a laser pointer as an additional feature for the remote control apparatus for computer. The user (500) can use this laser pointer while they use the remote control apparatus during presentation. The projected laser beam in front of the transmitter (200a) transforms a demonstrative laser point to indicate the specific location on the board or the screen. The user (500) connects the receiver (100) to the USB port (301) of said local computer (300), and controls the keypad (211) of the transmitter (200) from a distance. Therefore, the remote control computer device has the convenient features for the presentation user by performing as a remote controller as well as a laser pointer by utilizing the transmitter (200).

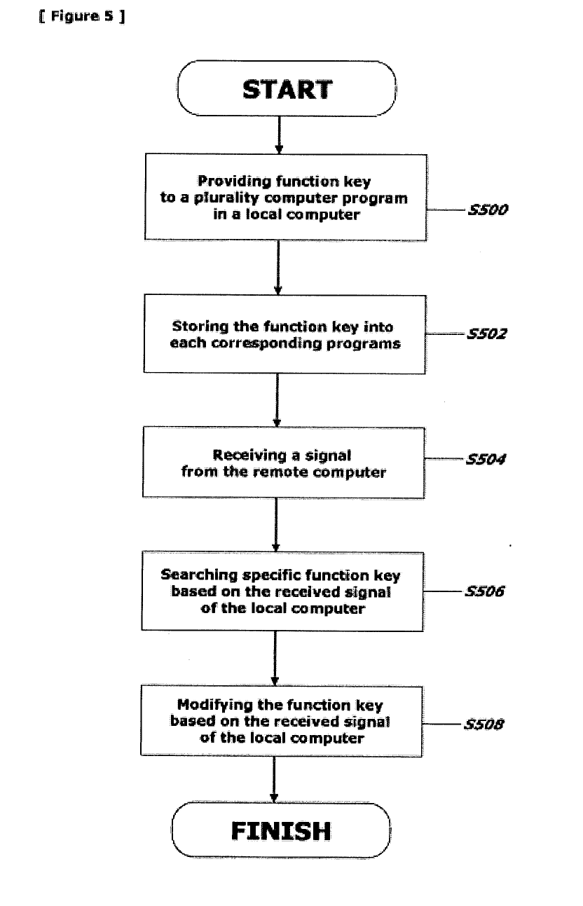

FIG. 5 is a block diagram of a method, which controls function key per each corresponding programs. The function key can be modified as much as the user wants to use different programs. This diagram illustrates the procedures of modifying the function keys: User provides function keys to a plurality computer program in the local computer (S500), and stores said function key into each corresponding programs (S502). In addition, a set up for the function key can be added, deleted or modified at any time. The local computer receives key signal from said remote control apparatus (S504), and searches specific function key based on said received key signal (S506). And then, the received key signal based on the retrieved function key information will be sent to the control part of an activated program (S508).

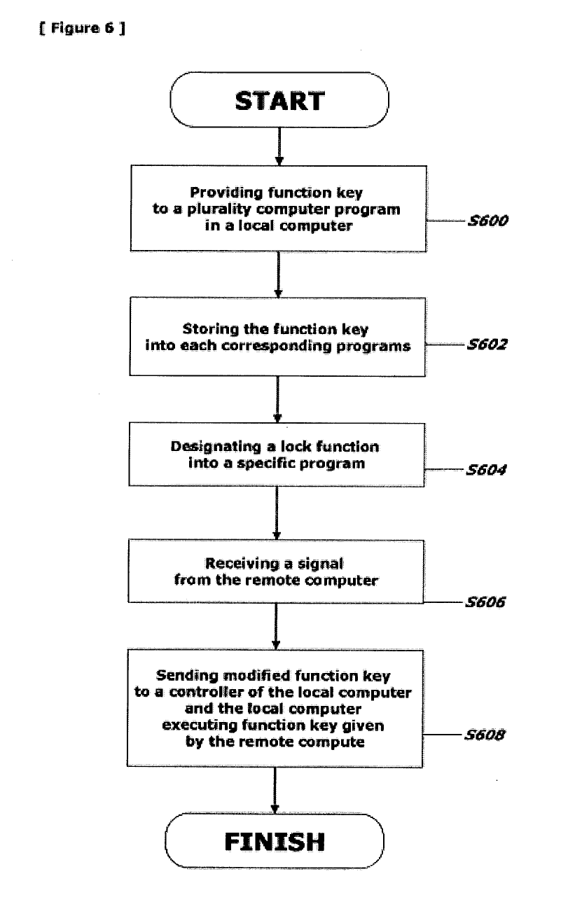

FIG. 6 is a block diagram of a method, which provides lock function to a designated program in the local computer. User designates the lock function to a specific computer program, and it works in a user designated computer program only whether or not the designated program is active, while non-designated program stays unaffected. It is possible to control various computer programs and to interface the multi task with one computer, once user set up the lock function on the local computer.

User in advance based onto the plurality computer program in a local computer provides function key (S600), and stores function key information per each corresponding programs (S602). In addition, the information of said function key can be added, deleted, or modified at anytime. Once the lock function is established on the designated program (S604), and it affects to the designated program only, and the set-up can be modified at any time. Once the lock function is established, the remote control apparatus transmits the key signal (S606) to the designated program only, and it does not affect any other programs (S608).

Described method of controlling function key of local computer per each corresponding programs in the remote control apparatus can be stored in a recording medium such as CD-Rom, Ram, Rom, Floppy Disk, etc. Although the invention has been described in connection with several embodiments. It is understood that this invention is not limited to the embodiments disclosed, but is capable of various modifications that would be apparent to one of ordinary skill in the art.

What is claimed is:

1. A method of controlling local computer by remote computer utilizing function keys, comprising steps of:
Providing function key to a plurality computer program in the local computer and storing said function key into each corresponding programs; receiving a signal from said remote computer and searching specific function key based on said received signal of said local computer; modifying said function key based on said received signal of said local computer and sending modified function key to a controller of said local computer and the local computer executing function key given by said remote computer.

2. The method of controlling local computer by remote computer utilizing function keys of claim 1, further comprising steps of;
Setting lock function on said local computer per each corresponding program designated by user followed by said steps of providing said function key to a plurality computer program in the local computer and storing said function key into each corresponding programs; receiving a signal from said remote computer and searching specific function key based on said received signal of said local computer; modifying said function key based on said received signal of said local computer and sending modified function key to a controller of said local computer and the local computer executing function key given by said remote computer.

3. The method of controlling local computer by remote computer utilizing function keys of claim 2, wherein the lock function works in a user designated computer program only whether or not the designated computer program is active, while non-designated computer program stays unaffected.

4. The method of controlling local computer by remote computer utilizing function keys of claim 3, wherein the lock function further comprises multi-tasking interface, wherein a computer allows simultaneous control of a plurality computer program with each remote control apparatus.

5. The method of controlling local computer by remote computer utilizing function keys of claim 1 and 4, wherein said function key for each corresponding programs can be added, deleted, or modified at any time.

6. The method of controlling local computer by remote computer utilizing function keys, further comprising steps of;
Providing function key to a plurality computer program in the local computer and storing said function key into each corresponding programs; Setting lock function on said local computer per each corresponding program designated by user; receiving a signal from said remote computer and searching specific function key based on said received signal of said local computer; modifying said function key based on said received signal of said local computer and sending modified function key to a controller of said local computer and the local computer executing function key given by said remote computer.

7. The method of controlling local computer by remote computer utilizing function keys of claim 6, wherein said lock function works in a user designated computer program only whether or not the designated computer program is active, while non-designated computer program stays unaffected.

8. The method of controlling local computer by remote computer utilizing function keys of claim 6 and 7, wherein said lock function further comprises multi-tasking interface, wherein said local computer allows simultaneous control of a plurality computer program with each remote control apparatus.

9. Recording medium to read plurality computer program in said local computer utilizing function keys, comprising steps of:
Providing function key to a plurality computer program in the local computer and storing said function key into each corresponding programs; receiving a signal from said remote computer and searching specific function key based on said received signal of said local computer; modifying said function key based on said received signal of said local computer and sending modified function key to a controller of said local computer and the local computer executing function key given by said remote computer.

10. Recording medium to read plurality computer program in said local computer utilizing function keys of claim 9, further comprising steps of:
Setting lock function on said local computer per each corresponding program designated by user followed by said steps of providing said function key to a plurality computer program in the local computer and storing said function key into each corresponding programs; receiving a signal from said remote computer and searching specific function key based on said received signal of said local computer; modifying said function key based on said received signal of said local computer and sending modified function key to a controller of said local computer and the local computer executing function key given by said remote computer.

11. Recording medium to read plurality computer program in said local computer utilizing function keys, comprising steps of:
Providing function key to a plurality computer program in the local computer and storing said function key into each corresponding programs; Setting lock function on said local computer per each corresponding program designated by user; receiving a signal from said remote computer and searching specific function key based on said received signal of said local computer; modifying said function key based on said received signal of said local computer and sending modified function key to a controller of said local computer and the local computer executing function key given by said remote computer.
